(19) United States
(12) Patent Application Publication
(10) Pub. No.: US 2022/0405578 A1
(43) Pub. Date: Dec. 22, 2022

(54) MULTI-MODAL FUSION

(71) Applicant: Anno.Ai, Minnetonka, MN (US)

(72) Inventors: Ashley Antonides, Minnetonka, MA (US); Alex Witt, Minnetonka, MA (US); Steven Witt, Minnetonka, MA (US)

(21) Appl. No.: 17/553,964

(22) Filed: Dec. 17, 2021

Related U.S. Application Data
(60) Provisional application No. 63/211,274, filed on Jun. 16, 2021.

(51) Int. Cl. G06N 3/08; G06K 9/62

(52) U.S. Cl. CPC G06N 3/08; G06K 9/6289; G06K 9/6256; G06K 9/6293

(57) ABSTRACT

Methods, systems, and apparatus, including computer programs encoded on computer-readable media, for obtaining, from a first sensor, first sensor data corresponding to an object, wherein the first sensor data is of a first modality; providing the first sensor data to a trained neural network; and generating second sensor data corresponding to the object based at least on an output of the trained neural network, wherein the second sensor data is of a second modality that is different than the first modality.

### CROSS-REFERENCE TO RELATED APPLICATIONS

This application is a Utility from Provisional of U.S. Application Ser. No. 63/211,274, filed Jun. 16, 2021, now pending, the entirety of which is incorporated by reference.

### FIELD

This specification generally relates to systems that use machine learning and collected sensor modalities for multi-modal fusion.

### BACKGROUND

Surveillance systems may include one or more sensors that collect data. The data may be processed either using processors onboard the sensor or by sending sensor data to a computer that is configured to process the sensor data.

### SUMMARY

One innovative aspect of the subject matter described in this specification is embodied in a method that includes obtaining, from a first sensor, first sensor data corresponding to an object, where the first sensor data is of a first modality; providing the first sensor data to a neural network trained to convert from the first modality to a second modality; and generating second sensor data of the second modality corresponding to the object based at least on an output of the trained neural network, where the generated second sensor data is of the second modality that is different than the first modality.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, actions include training the neural network, where training the neural network includes: obtaining training data of the first modality; generating third sensor data of the second modality using the neural network based on the training data of the first modality; generating data of the first modality using the neural network based on the generated third sensor data of the second modality; and adjusting one or more weights of the neural network based on a difference between the training data of the first modality and the generated data of the first modality.

In some implementations, actions include detecting, using one or more other sensors, the object based on the generated second sensor data of the second modality. In some implementations, the object is a human or a vehicle.

In some implementations, the neural network is trained using a plurality of data modalities to learn one or more latent spaces between at least two data modalities of the plurality of data modalities, where the at least two data modalities include the first modality and the second modality.

In some implementations, actions include obtaining, from a third sensor, third sensor data corresponding to the object where the third sensor data is of a third modality; providing the third sensor data and the first sensor data to the trained neural network to generate the output of the trained neural network; and generating the second sensor data of the second modality based on the output of the trained neural network.

In some implementations, actions include determining that the generated second sensor data of the second modality satisfies a threshold value; and in response to determining that the generated second sensor data satisfies the threshold value, providing output to a user device indicating a capability of the neural network to replace data of the second modality obtained by a second sensor with the generated second sensor data.

In some implementations, a distance between a location of the first sensor and a location of the second sensor satisfies a distance threshold. In some implementations, the first sensor and the second sensor are included within a sensor stack.

In some implementations, generating the second sensor data of the second modality includes: generating, based on the first sensor data, additional data representing the object, where the additional data is of the second modality. In some implementations, actions include identifying the object based on the additional data of the second modality.

In some implementations, actions include obtaining, from a second sensor, third sensor data of the second modality, where the third sensor data represents a portion of the object.

In some implementations, the third sensor data of the second modality is a result of data degradation and represents a portion of the object that is less than the whole object due to the data degradation. In some implementations, the data degradation is due to environmental conditions.

In some implementations, actions include providing the third sensor data of the second modality to the neural network trained to convert from the first modality to the second modality, where the output of the trained neural network is generated by processing the first sensor data and the third sensor data.

In some implementations, actions include generating a plurality of cost metrics for two or more groupings of a plurality of sensors used to obtain data, where a grouping of the two or more groupings includes at least one sensor of the plurality of sensors, and where the plurality of sensors includes the first sensor that obtains data of the first modality a second sensor that obtains data of the second modality; and selecting a first grouping of the two or more groupings based on the plurality of cost metrics to be included in a sensor stack, where the first grouping includes the first sensor and not the second sensor.

In some implementations, the plurality of cost metrics are calculated, for each of the two or more groupings, as a function of one or more of a size of each sensor in the grouping, a weight of each sensor in the grouping, power requirements of each sensor in the grouping, or a cost of each sensor in the grouping.

In some implementations, actions include generating a data signal configured to turn off one or more sensors in one or more sensor stacks, where the one or more sensors are not included in the selected first grouping; and sending the data signal to the one or more sensor stacks.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for multi-modal fusion.

FIG. 2 is a diagram showing an example of a system including a generative adversarial network (GAN) for multi-modal fusion.

FIG. 3 is a diagram showing an example of generating sensor data of a second type using sensor data of a first type.

FIG. 4 is a flow diagram illustrating an example of a process for multi-modal fusion.

FIG. 5 is a diagram showing an example of a system for obtaining sensor data.

FIG. 6 is a diagram showing an example of a computing system used for multi-modal fusion.

FIG. 7 is a flow diagram illustrating an example of generating additional data of a data type.

FIG. 8 is a flow diagram illustrating an example of adjusting a sensor stack based on cost metrics.

Like reference numbers and designations in the various drawings indicate like elements.

### DETAILED DESCRIPTION

In some implementations, electronic devices, including one or more sensors, may be used to obtain sensor data. For example, a sensor may obtain data corresponding to an object of a first type, such as synthetic-aperture radar (SAR) data, and provide the data to a trained neural network. In some implementations, the neural network may be trained as a generative adversarial network (GAN) to produce output based on the data. The output may include data of a second type, such as electro-optical (EO) data. The neural network may be trained using one or more training data sets that include data of a first type representing an object or event and data of a second type representing the same object or event.

In some implementations, a system may be configured to use synthetically generated sensor data to track a missing person, fugitive, vehicle, or other object. For example, a deployed sensor stack may only include 3 sensors but may generate a signature based on, at least, a fourth type of synthetic sensor data. The signature generated based on, at least, the fourth type of synthetic sensor data may then be used to identify a person or object even if one or more of the actual sensors are compromised, thereby increasing accuracy and robustness of a detection and identification system.

In general, any number or type of data may be generated synthetically by a trained neural network as described herein. In some cases, by compromising 1 of the 3 sensors in the previously mentioned example of a sensor stack, a person or object may avoid identification. However, by increasing the sensor data used to compare with other occurrences within a system through synthetic generation of sensor data generated by a trained neural network, a system may increase the accuracy and efficiency of identification without increasing cost of deploying or maintaining sensor stacks.

Advantageous implementations can include one or more of the following features. For example, after training a machine learning network to generate data of a second type based on input data of a first type, a system may deploy the machine learning network to reduce the number of sensors required at a given site. In this way, the trained network may reduce the costs associated with a system used to obtain and process sensor data.

In some implementations, one or more parameters may be used to calculate a cost associated with each sensor. For example, the size, weight, power, and cost (SWaP-C), as well as any corresponding related calculations including a subset of these calculations, may be calculated. A group of one or more sensors may be chosen to minimize the SWaP-C in a given deployment scenario. By using a trained network to generate data of types not obtained, a system may reduce the SWaP-C by not including particular sensors in a sensor array and instead generating them using the trained network.

In some implementations, sensor deployments may be sensitive to SWaP-C. For example, SWaP-C may increase depending on a number of system parameters including the volume of data generated by deployed sensors and the number of sensors deployed. By using a trained neural network to approximate data of a type not obtained using deployed sensors, the SWaP-C of a given system may be reduced. For example, an acoustic sensor may yield similar operational accuracy to a more expensive or data intensive video sensor. A neural network may be trained to generate intensive video sensor data based on one or more collected data types including acoustic sensor data thereby eliminating the need to deploy the more expensive data intensive video sensor and thereby reducing the SWaP-C of the system. This may be especially advantageous in fields where SWaP-C is especially limited, such as in the field of aerial drone deployment.

Advantageous implementations may further provide robustness against adversarial attacks. For example, an adversarial attack may compromise a given sensor's ability to obtain data. However, by using multiple input sensor data types to generate new data from a trained neural network, adversaries would need to compromise multiple input sources across multiple data types in order to compromise the resulting data produced by a neural network and therefore the functioning of the system. Thus, by generating data using a neural network operating on data of multiple modalities, the system may increase robustness in proportion to the number of sensors deployed and methods for training and generating resulting data. The system may account and respond to adversarial measures by coordinating use of sensors less likely to be impacted by active countermeasures. For example, if an adversarial system attempts to limit bandwidth for imagery sensors, the sensor network may invoke short range wireless sensors. The short range wireless sensors may provide excerpts of collected data where the excerpts can be used to identify data related to the object previously the subject of the imagery sensors.

A system may perform one or more operations based on obtained sensor data including, for example, identification of one or more elements represented in the sensor data and generating alerts based on the identification.

Systems may have corresponding costs that include costs for deployment and operation. For example, deployment costs may include purchasing or manufacturing one or more sensors as well as installation of the one or more sensors at a predetermined site. Operation costs may include maintenance, installation, or service costs of connectivity networks, such as an Internet-based network. A network may be configured to allow for sensor data to be sent by a sensor to a processing computer. Operation costs may also include energy supplied to the one or more sensors in order for the one or more sensors to obtain sensor data.

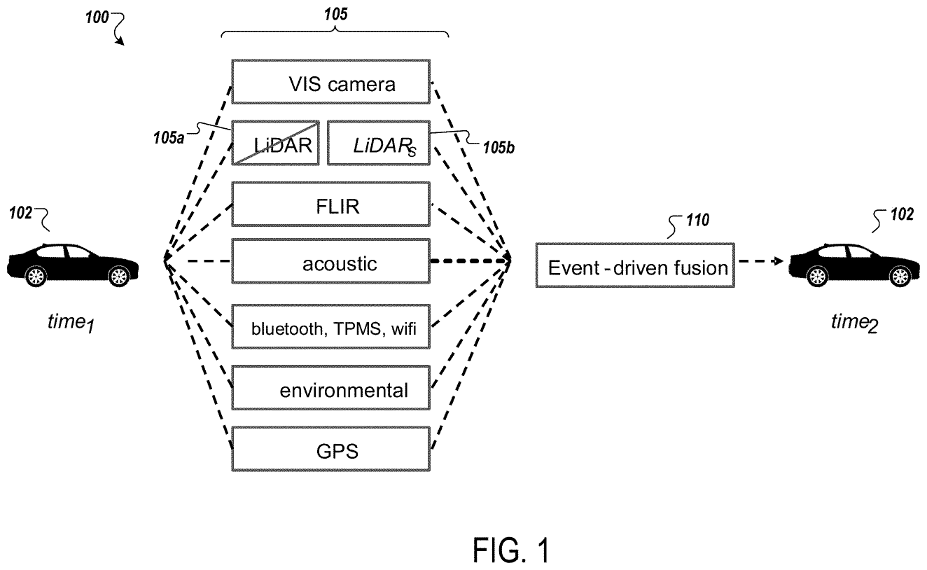

FIG. 1 is a diagram showing an example of a system 100 for multi-modal fusion. The system 100 may include a sensor stack 105. The sensor stack 105 may include one or more sensors, such as a visible light camera, a light detection and ranging (LiDAR) sensor, a forward-looking infrared (FLIR) sensor, an acoustic sensor, a Bluetooth sensor, a tire pressure monitor system (TPMS), Wi-Fi sensor, an environmental sensor, and a global positioning system (GPS) sensor. In FIG. 1, LiDAR sensor 105a is compromised but may be replaced with a synthetic LiDAR sensor 105b. The synthetic LiDAR sensor 105b may include a machine learning network trained based on one or more data types of the sensor stack 105 to generate LiDAR data corresponding to the one or more other data types.

Depending on implementation, the sensor stack 105 may include more or fewer sensors. For example, one or more sensors may be added or removed from the sensor stack 105 in order to obtain sensor data from a determined number of sensor data types or determined types of data types. Sensor data from the sensor stack 105 may be represented in one or more ways, including vector form where data of the vector indicates features of the obtained sensor data.

In some implementations, a sensor may include one or more different types of sensors. For example, an environmental sensor may include temperature sensors, humidity sensors, barometric pressure sensors, air quality sensors, among others. In another example, an acoustic sensor may include one or more sensors for sensing near infrasound to far ultrasound. A Wi-Fi network may be configured to detect both wireless networks and devices capable of transmitting Wi-Fi signals.

At a first time, as shown in the example of FIG. 1, an event occurs. In this example, the event includes a car 102 passing within a sensing radius of one or more sensors of the sensor stack 105. The one or more sensors of the sensor stack 105 obtain sensor data corresponding to the event of the car 102.

One or more data sensors of the sensor stack 105 may be compromised. For example, the LiDAR sensor 105a may be compromised but corresponding sensor data may be generated synthetically using a trained neural network. Data of the synthetic LiDAR sensor 105b may be combined with the other obtained sensors data for event driven fusion 110.

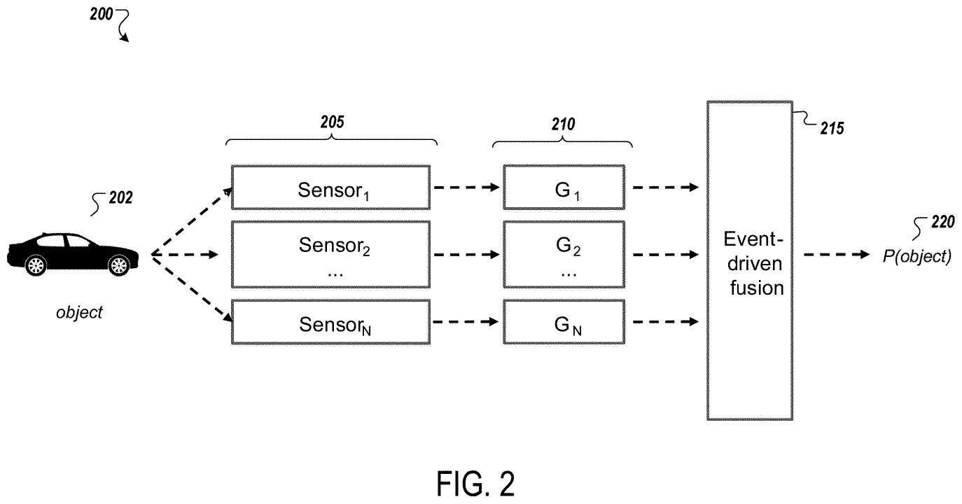

The event driven fusion 110 may be performed by one or more computers of the system 100. For example, data of the sensor stack 105 may be obtained by one or more sensors of the sensor stack 105 as discussed herein. The one or more sensors of the sensor stack 105 may provide the corresponding sensor data to the one or more computers configured to perform the event driven fusion 110. The process corresponding to the event driven fusion 110 is discussed in FIG. 2.

Based on the fused data obtained from the event driven fusion 110, the system 100 may store data corresponding to the event of the car 102. At a later time, the car 102, having passed within the sensing range of the sensor stack 105, may be identified as the same car as the event at the first time based on the data obtained from the event driven fusion 110. Because the identification is based on a broad range of sensor data types included in the sensor stack 105, as well as one or more synthetically generated data items, the identification is more robust to scene or environmental changes or compromised sensors.

In some implementations, the system 100 obtains data from multiple different sensors in the sensor stack 105 to generate the event driven fusion 110. For example, a visual camera in the sensor stack 105 can obtain visual data of the car 102 at a first time. At a later time, an acoustic sensor in the sensor stack 105 can obtain acoustic data generated by the car 102 (e.g. engine noise or noise caused by the car 102 moving down the road).

In some of these cases, the system 100 uses sensor specific windows to correlate data from different sensors. For example, data captured within a first window in time by a first sensor may be combined with data captured by a second sensor within a second window in time to be included in the event driven fusion 110. The first window and the second window can be determined based on features of the first sensor and the second sensor as well as features of the surrounding environment. For example, an acoustic sensor of the sensor stack 105 may be able to detect the car 102 before a visual camera of the sensor stack 105 obtains visual data of the car 102.

In some implementations, features used to determine sensor data windows include location information. For example, each sensor can include identifying information that includes location information. Based on the location information corresponding to each sensor, the system 100 can determine the distance between each sensor. If a distance (e.g., Euclidean distance) between two sensors satisfies a threshold (e.g., less than a maximum distance, within a range of allowable distances, among others), the system 100 can combine sensor data from the two sensors into a single event.

In some implementations, the system 100 determines data windows for sensor combination based on one or more features. For example, if the distance between two sensors satisfies a threshold, the system 100 can determine additional features of the sensor data to determine sensor data windows within which to combine data for event drive fusion. Additional features can include sensor type, positioning, weather conditions, actions by objects in a corresponding environment, among others. In general, the type of sensor can determine the effects of other determined features on the sensor data window.

In some implementations, the system 100 uses known sensor types to determine sensor data windows. For example, if a particular sensor type or particular sensor suffers latency when obtaining data, the system 100 can adjust a window of time within which to capture data for combination. The window of time can be adjusted by the latency amount. The system 100 can determine latency based on training data of specific events and apply the latency adjustment for data obtained in the future. For example, a car driving past a sensor stack may be registered at time t1 on a first sensor and at a later time t2 on a second sensor. The event may end at time t3 for the first sensor and time t4 for the second sensor. Based on the car driving event, the system 100 can determine that the second sensor has an initial latency equivalent to t2 minus t1 and a secondary latency equivalent to t4 minus t3. When combining sensor data from different sensors, the system 100 can use different windows of time for different sensors. The different windows of time can be separated at the beginning by the initial latency and at the end by the secondary latency.

In some implementations, the system 100 determines position of sensors within a sensor stack such as sensor stack 105. The system 100 can determine positioning from data received directly from users or the sensors. The system 100 can determine position by detecting elements of an environment depicted in sensor data from a sensor and matching the detected elements of the environment to known elements of the environment to determine the position of the sensor.

In some implementations, the system 100 uses positioning of sensors to determine sensor data windows. For example, if a first sensor is pointed eastbound on a road and a second sensor is pointed westbound on a road, the system 100 can use the positioning of the sensors to determine relevant windows for event driven fusion. In particular, the system 100 can determine, if the first sensor detects an object moving on the road at a first time and the second sensor detects an object moving on the road at a second time after the first time, that the sensor data window for the second sensor should cover a period of time after the sensor data window for the first sensor. If, instead, the second sensor detects the object moving on the road first, the sensor data window for the second sensor should cover a period of time before the sensor data window for the first sensor.

In some implementations, the system 100 determines weather conditions at a location of a sensor stack. For example, the system 100 can obtain weather data from a weather tracking service. The system 100 can determine weather data based on obtained sensor data from one or more sensors on the sensor stack 105. For example, fog, as well as precipitation, can be detected based on image data. The system 100 can provide sensor data to a trained model to determine weather corresponding to the sensor data. The model can be trained based on data originating from known weather conditions at a sensor stack location.

In some implementations, the system 100 uses weather conditions to determine sensor data windows. In general, sensors may be affected by inclement weather. For example, visual sensors detect objects further away when there is no fog, precipitation, or other obscuring factor compared to when there is. Based on the weather and the type of sensor, as well as the intensity of the weather, the system 100 can adjust the window for event driven fusion. For example, if there is fog, a visual camera may need an object to pass closer to detect the object. That may require a sensor data window for the visual camera to start after a sensor data window for a sensor that is not as affected by the fog, such as a Bluetooth or WiFi sensor, or after a predetermined time relative to other sensor data windows when there is no inclement weather.

In some implementations, the system 100 detects actions by objects in an environment. For example, a visual camera on the sensor stack 105 can obtain sensor data depicting a car. The system 100 can detect the car within the sensor data at a particular time within the sensor data. At this time, the system 100 can start the sensor data window for that sensor. When, in processing subsequent portions of the sensor, the object is no longer detectable, the system 100 can stop the sensor data window for that sensor. The system 100 can perform object detection for each sensor type. When sensor data windows for multiple sensors overlap in time, the system 100 can combine the data for event drive fusion.

FIG. 2 is a diagram showing an example of a system 200 including a generative adversarial network (GAN) that includes generators 210 for multi-modal fusion. The generators 210, for example, generators G₁, G₂, . . . , G_{N}, correspond to each sensor in sensor stack 205. The system 200 may be used to perform fusion, such as the event driven fusion 110 of FIG. 1.

The system 200 includes the sensor stack 205 similar to the sensor stack 105. The sensor stack 205 includes one or more sensors that obtain data used as input for each generator of the generators 210. The output for each generator of the generators 210, corresponding to sensor data provided by a sensor, may include a structure representing an estimate of a latent space between two or more sensor modalities (e.g., SAR data to EO data). The structure may be of a dimension corresponding to the dimension of the latent space and be populated with values corresponding to one or more features extracted from the corresponding sensor data.

The GAN of the system 200 may include one or more layers including one or more pooling layers, convolutional layers, and fully connected layers. A rectified Linear Unit (ReLU) may be used in between one or more layers as a non-linear activation function, such as a sigmoid function or hyperbolic tangent, among others. In some implementations, the fully connected layers of the GAN may be used to transform preceding input into the dimension corresponding to the latent space. For example, one or more fully connected layers may be the last layers within a generator of the generators 210 in order to generate a corresponding estimation of the latent space between two or more sensor modalities.

In some implementations, each of the sensors in the sensor stack 205 may obtain data that is used as input for a corresponding generator of the generators 210. In some cases, the input data may be represented as one or more vectors. After processing by one or more layers of the GAN, a latent space may be learned as a multi-dimensional matrix.

In these or other implementations, features may be selected from the learned latent space. For example, a selection may be performed using one or more matrix calculations and a selection matrix that selects a portion of the one or more vectors corresponding to a given sensor for each of the sensors of the sensor stack 205.

Alternatively, or in addition, the selection may be performed based on an output of a discriminator operating on the latent space learned by a given generator. For example, a given generator of the generators 210 approximates a mapping between selected features of the sensor data obtained by one or more sensors of the sensor stack 205 and a latent space between the one or more sensors and one or more desired synthetic sensor data types. A discriminator network based on the resulting latent space may be used to determine a latent space that accurately estimates the latent space between the two or more sensor modalities.

A discriminator network operating on the output of one or more generators may be trained using labeled data including sensor data from two or more sensor modalities. The generator may be trained to generate a latent space structure, such as a multi-dimensional tensor or matrix, between the two or more sensor modalities while the discriminator may be trained to compare the latent space structure with the labeled data in a given training set.

In some implementations, training data for the GAN of the system 200 may include unpaired data. For example, sensor data captured in one sensor modality may represent a bird passing within a sensing range from a first sensor while sensor data captured in another sensor modality may represent the same bird passing within a sensing range from a second sensor. The first sensor and the second sensor need not represent the bird in the same moment of time. For example, the first sensor may capture data of the bird flying at a distance of 10 meters away from the first sensor to 5 meters away while the second sensor captures data from 7 meters to 5 meters.

Whether the data is paired or unpaired, the system 200 may be trained to combine sensor data from multiple sensor modalities in order to identify objects or portions of an object depicted in sensor data. For example, in the bird flying example discussed herein, because the data corresponds to the same event of the bird flying into the one or more sensing ranges, both the data from the first sensor and the data from the second sensor may be combined to form a signature of a bird flying event in order to identify future bird flying events. In some cases, future events may be identified by comparing one or more stored signatures of past events with a newly obtained signature that includes newly captured sensor data.

Decisions corresponding to the estimations generated by the generators 210 may be combined using event driven fusion 215. For example, a visual sensor may detect one or more patterns of pixels as corresponding to a particular decision that an object is present based on sensor data from the first visual sensor. One or more other sensors in the sensor stack 205 may obtain sensor data corresponding to one or more other decisions. For example, the sensor stack 205 may include acoustic sensor data. Based on processing by one or more networks, such as the GAN of the system 200, sensor data, as well as synthetic sensor data corresponding to each of the sensors, may be used to identify one or more objects represented in the sensor data. The event driven fusion 215 may combine the decisions corresponding to one or more represented objects in the plurality of sensor data, and correlate the data from the plurality of sensor data to an event, where the event may be identified by a signature created by the combination.

The system 200 may be used to generate object probabilities 220. For example, a weighted summation of all object detections corresponding to the data collected by the sensor stack 205 may be computed as the object probabilities 220. The object probabilities 220 may be compared to one or more other probabilities. In some cases, the probabilities may be included in a signature that represents a particular event. If a comparison between a first signature and a second signature satisfies a determined threshold, the first signature and the second signature may be determined to be corresponding to the same or similar event. A comparison between a first signature and a second signature can satisfy a determined threshold by being equal to, greater than, or less than the determined threshold, depending on implementation. A comparison can include a difference value equal to one or more values of a first signature subtracted from one or more values of a second signature. A comparison can include a difference value equal to one or more values of a second signature subtracted from one or more values of a first signature.

In some implementations, the GAN is trained to convert data of one sensor modality to another modality. In general, modality of a sensor may be equivalent to a sensor data type. For example, the GAN can be trained to convert from a first data modality to a second data modality by converting initial data of the first modality to the second modality, and then again converting the resulting data in the second modality back to the first modality, obtaining twice-converted data. The GAN compares the initial data to the twice-converted data. In the case of training the GAN to convert between EO and infrared data, the GAN can be trained by converting either the EO or the infrared data. The GAN can convert initial EO training data to infrared data. The GAN can then convert the resulting infrared data back to EO data and compare with the initial EO training data as a ground truth. The GAN can then update weights and parameters of the GAN such that, in future training or application, the twice converted data satisfies a difference threshold when compared to the initial data.

In some implementations, the GAN is trained to convert data of multiple sensor modalities to one or more other modalities. For example, the GAN can be trained to convert from a first set of one or more modalities to a second set of one or more modalities. Similar to the conversion between single modalities, the GAN can be trained using initial data of multiple sensor modalities and then converting the initial data to one or more other sensor modalities based on the initial data.

In some implementations, the GAN obtains ground truth data that includes multiple sensor modalities of the sensor stack capturing an event. For example, the GAN can obtain ground truth data that includes the event of detecting the car 102 captured in all the modalities of the sensor stack 105, for example including visual camera data, LIDAR data, FLIR data, acoustic sensor data, Bluetooth sensor data, TPMS data, Wi-Fi sensor data, environmental sensor data, and GPS system sensor data. The GAN can generate LIDAR data, or data of another modality, based on the obtained ground truth data. The GAN can compare the generated data to the ground truth data to update its weights and parameters. For example, the GAN can determine the difference value between the generated data and the ground truth data and, based on the difference, can adjust weights and parameters in one or more layers of the GAN.

In some implementations, a discriminator of the GAN determines one or more difference values. For example, a discriminator model of the GAN, including generators G₁, G₂, . . . , G_{N}, can generate one or more values indicating a likelihood that the generated data is ground truth data.

In some implementations, a threshold for event determination may be dynamically adjusted based on the state of the sensor network or the object of interest. For example, if a wider area is under investigation, a network administrator may wish to receive more alerts knowing that many of the alerts will be false positives. Alternatively, if the controlling system is trying to find classes of events (e.g., hostile activity by multiple actors), then the lower threshold may be used to capture information related to each of the events. On the other hand, if a unique object is being tracked across a region, then the thresholds may be raised to precisely track object movement across the region. In addition, the threshold can change. For example, the sensor network may first identify a class of events (e.g., a particular type of transaction or activity). Once the event has been identified, objects associated with the event may be tracked in the sensor network. This, in turn, may lead the system to identify other activities associated with the object/individual. And, if the sensor network determines that the object or individual cannot be consistently or reliably tracked, the newly identified other activities can be tracked in order to acquire the individual in the future.

In some implementations, signatures may be stored within memory. For example, a signature may be stored as a tensor within memory communicably connected to a computing device. The tensor representing a given signature may be assigned a label. The label may be assigned either by using pre-labeled training data, and thereby applying the label of the pre-labeled training data to the tensor, by human review, where a human may label the tensor based on reviewing the sensor data that was used to generate the corresponding signature, or by a successful comparison with a stored tensor corresponding to a signature. A successful comparison may include computing a distance between parameters of one tensor to another tensor. Multiple tensors may be compared to determine the relative difference between their corresponding values. In some cases, the tensors may be used to generate a distance measurement in a multi-dimensional space. If the difference or distance measurement satisfies a threshold, one or more tensors being compared to one or more stored and labeled tensors may be labeled the same as the stored and labeled tensors. Alternatively, the tensor may be auto generated by a classifying system. For example, the system may identify aspects believed to be significant without understanding the basis for that significance. Thus, the tensor can be used in analytical operations to identify relationships between different data sets and objects.

In some implementations, the system 200 may use the object probabilities 220 to output a decision to a user. For example, in addition, or as an alternative, to storing for identification, the system 200 may compare the object probabilities 220 to one or more thresholds. Each threshold may correspond to a particular event such as a car passing or a human. Based on comparing the object probabilities 220 to one or more thresholds, the system 200 may provide a user with an indication of what event occurred.

In some implementations, the events corresponding to event driven fusion may be more specific. For example, discussed herein are examples of identifying objects such as a car or a bird. Other objects may include humans and aircraft among others. In addition, the events may correspond to only one particular object, such as a first person with certain features. The features may be represented within a tensor corresponding to the signature provided by a corresponding event driven fusion event. The features may represent features of the person such as eye color, hair, facial features, body type, height, gait, among others. The generator corresponding to one or more sensors of the sensor stack 205 may generate corresponding features that may be used to generate a corresponding tensor sufficient to detect the same human from a number of other similar humans. The same process may be applied to other objects in order to save, and be able to identify, occurrences of particular objects within sensor data.

In some implementations, objects to track may be more or less mutable. For example, a human may be more mutable than a vehicle. When tracking a human, a system may rely on other sensors, or abstractions of sensor data, in order to reduce reliance on general appearance which may change significantly especially if the human is attempting to evade identification with a disguise or other method to compromise one or more sensors. For example, a mask may significantly alter the appearance of a face but may not alter the appearance of the body, hair color, thermal readings, heartbeat, or other parameters that may be sensed by sensors of a sensor stack. In this way, those sensors may be weighted more than mutable sensor data, such as visual data from a visual camera. When tracking a vehicle, the system may include larger weights to favor an event signature that focuses on dimensions or immutable characteristics of the car such as license plate or geometric shape. In this way, the system may optimize the types of features, e.g., more mutable or immutable, depending on the object to be tracked or identified.

In some implementations, event driven fusion may be used to identify particular object features. For example, an event may include a vehicle passing within a sensing range. The vehicle may have a license plate affixed to it. In some cases, the generators 210 corresponding to one or more sensors of the sensor stack 205 may estimate a latent space that represents the features of the license plate, such as the collection of characters or symbols that are used on the license plate for identification. In some cases, the presence of a license plate may be weighted higher than other collected features in a corresponding summation in order to determine the identification of an object. However, other sensor data may still be included in order to obtain a corresponding signature and to prevent an adversarial attack that may compromise the appearance of the license plate. In this case, other sensor data including acoustic sensor data of the engine or road noise, seismic data indicating a weight or movement capabilities, thermal images indicating a heat profile of the vehicle, among many others, may be used in conjunction in order to generate a comprehensive signature to be used for identification.

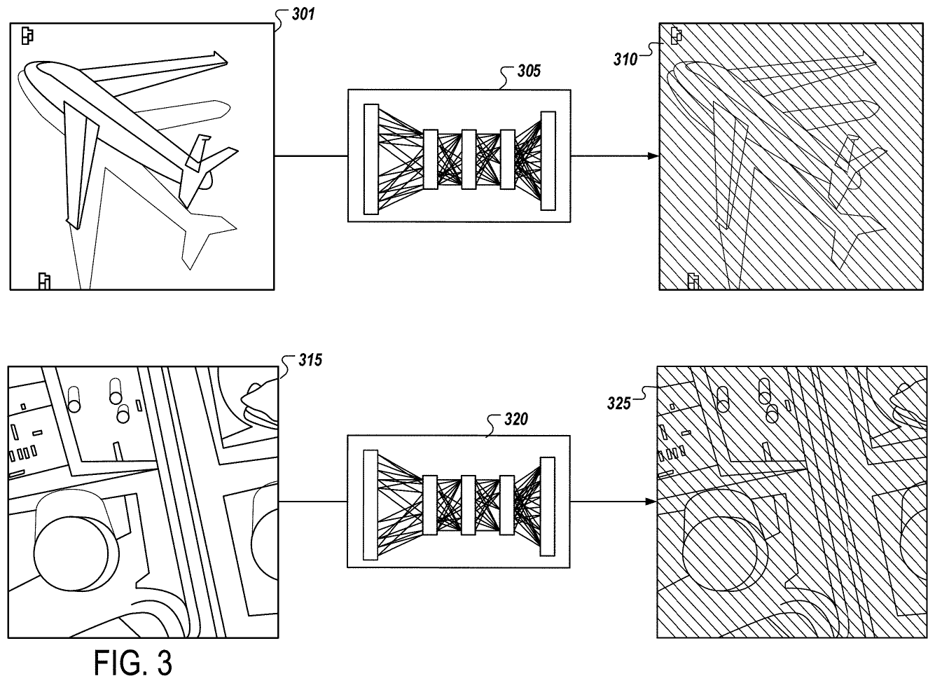

FIG. 3 is a diagram showing an example of generating sensor data of a second type using sensor data of a first type. A first image 301 represents an object. In this case the object is a plane but may be any object represented in the sensor data depending on implementation. A second image 315 represents an aerial view that may be used as part of a surveillance system. Both the first image 301 and the second image 315 are of a first sensor type. For example, both the first image 301 and the second image 315 may be synthetic-aperture radar (SAR) data items.

Neural networks 305 and 320 are trained to obtain data of the first type and generate data of a second type. In FIG. 3, the first type may be SAR data and the second type may be electro-optical (EO) data. The neural networks 305 and 320 may be trained using a training data set that includes data represented in both the first type and the second type.

In some implementations, the neural networks 305 and 320 may include one or more GANs. For example, the neural network 305 may include a first GAN that is trained to generate a data item that approximates data of a second type based on input data of a first type (e.g. the neural networks 305 and 320 can be trained to convert between data modalities as discussed with reference to FIG. 2). A generator of the first GAN may be used to generate a candidate data item as a representation of the data of the second type. A discriminator of the first GAN may obtain the candidate data item and, based on a stored data set indicating known data of the second type, may be configured to determine if the candidate data item is an accurate estimation of the data of the second type.

The neural network 305 may include one or more layers that include one or more operations including matrix operations, such as the layers discussed in reference to the GAN of the system 200. Each layer of the neural network 305, similar to the GAN of the system 200, may include one or more weights that may be adjusted based on training. In a training environment, the neural network 305 may include a first set of weights that may be adjusted to form an adjusted set of weights different from the first set of weights.

The neural network 305 obtains the first image 301 and generates, based on the first image 301, a synthetic first image 310 that is an estimation of the object represented in the first image 301 as data of the second type. The synthetic first image 310 represents an estimation, using data of a second type, of what the object would have looked like if sensor data of the same environment was obtained using a sensor that obtains data of the second type.

Similarly, the neural network 320 obtains the second image 315 and generates, based on the second image 315, a synthetic second image 325. Again, the synthetic second image 325 is an estimation of the aerial view represented by the sensor data of the second image 315 represented using data of the second type. The synthetic second image 325 represents an estimation, using data of a second type, of what the aerial view would have looked like if sensor data of the same environment was obtained using a sensor that obtains data of the second type.

In some implementations, the neural network 305 and the neural network 320 may include the same weights. For example, in a training scenario, a neural network may be trained to generate a representation of sensor data of a second type based on sensor data of a first type. The neural network may be deployed to eliminate the need to have a sensor actually obtain data of the second type at a given site, thereby reducing deployment and other operational costs. In this way, the neural network 305 and the neural network 320 may be the same neural network trained to generate representations using data of the second type.

Although the generation of synthetic sensor data is represented as a one data type in, one data type out process, in some implementations, the process may include one or more other data types. For example, in order to generate a representation of an object or environment using data of a second type, data of at least a first and third type may be required. The particular sensor data types may vary depending on implementation but, in at least one case, SAR data and infrared data from a SAR sensor and infrared sensor, respectively, may be used by a trained neural network to generate an accurate representation of a given object or environment in a representation of EO data.

In some implementations, the neural network 305 and the neural network 320 may have different weights. For example, in a training scenario, the neural network 305 may generate an estimation of the object using data characteristics of a second type. After back-propagation based on a known ground truth, such as an actual captured sensor data representing the object where the sensor data is of a second type, the weights of the neural network 305 may be updated to improve the generation of synthetic data. The neural network 320 may be the updated version of the neural network 305 with updated weights. The training process may iteratively process pairs of sensor data that correspond to the same event represented in different data types. The training data pairs may not necessarily represent an identical version of an object, environment, or representation, as discussed herein.

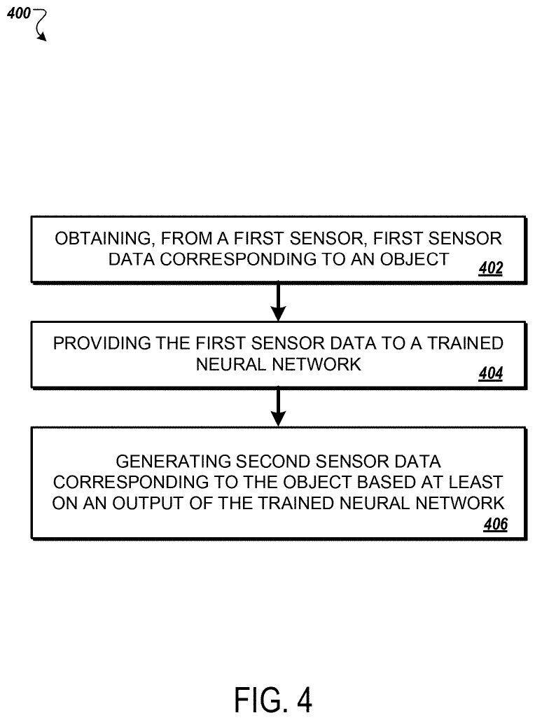

FIG. 4 is a flow diagram illustrating an example of a process 400 for multi-modal fusion. The process 400 may be performed by one or more electronic systems, for example, the system 100 of FIG. 1 or the system 200 of FIG. 2.

The process 400 includes obtaining, from a first sensor, first sensor data corresponding to an object (402). For example, the sensor stack 205 of FIG. 2 includes a plurality of sensors that obtain sensor data corresponding to the car 102. The types of sensors may include a visible light camera, a light detection and ranging (LiDAR) sensor, an infrared (IR) sensor, an acoustic sensor, a Bluetooth sensor, a tire pressure monitor system (TPMS), Wi-Fi sensor, an environmental sensor, and a global positioning system (GPS) sensor, among others. Each of the sensors may capture sensor data in a distinct modality. Each distinct modality may be referred to as a distinct sensor data type.

The process 400 includes providing the first sensor data to a trained neural network (404). For example, as shown in FIG. 3, data of a first type may be obtained by a system including a neural network, such as the neural network 305. The data of the first type may represent one or more objects, environments, or other features of sensor data such as a profile indicated by a seismograph.

The process 400 includes generating second sensor data corresponding to the object based at least on an output of the trained neural network (406). For example, as shown in FIG. 3, the neural network 305 generates the synthetic first image 310 based on the input of the first image 301. The synthetic first image 310 may be an estimation of the object represented in the first image 301 as data of the second type. In some cases, the synthetic first image 310 represents an estimation, using data of a second type, of what the object would have looked like if sensor data of the same environment was obtained using a sensor that obtains data of the second type.

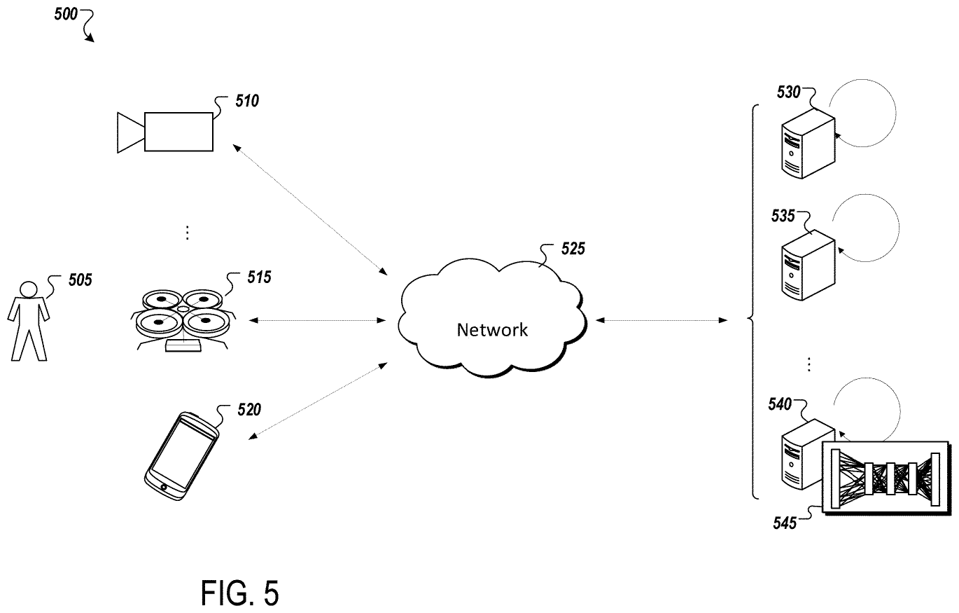

FIG. 5 is a diagram showing an example of a system 500 for obtaining sensor data. In general, the system 500 may be used to obtain sensor data for any system including the system 100 of FIG. 1, the system 200 of FIG. 2, and the system 300 of FIG. 3.

The system 500 includes a plurality of devices for obtaining sensor data including a visual sensor 510, a drone 515, and a smartphone 520. The system 500 includes a network 525 that may be used to send sensor data collected by the system 500 to processing components including processing component 530, processing component 535, and processing component 540.

In some implementations, the visual sensor 510 may be a camera. For example, the visual sensor 510 may be a surveillance camera that is configured to capture visual images of objects or environments. The visual sensor 510 may be attached to another device of the system 500. For example, the visual sensor 510 may be attached to the drone 515. In this way, the drone 515 may be configured to maneuver the visual sensor 510 in order to obtain sensor data from different viewing angles.

In some implementations, the drone 515 may be capable of autonomous movements. For example, the drone 515 may be equipped with propellers or other propulsion devices to move within an area. The drone 515 may be equipped with one or more sensors in order to move within a given space.

The smartphone 520 may be equipped with one or more sensors configured to obtain sensor data from a surrounding area. The sensor data from the surrounding area may be sent to processing devices of the system 500 or may be processed directly by computing elements of the smartphone 520.

The system 500 may use one or more devices, such as the camera 510, the drone 515, and the smartphone 520 to capture sensor data of an object or environment. in FIG. 5, the devices of the system 500 capture sensor data of person 505. The sensor data from the one or more devices of the system 500 are sent to one or more processing components of the system 500 or processed locally and a respective local device used to capture the sensor data.

In the example of FIG. 5, the sensor data captured by the devices of the system 500 are sent over the network 525 to the processing components including the processing component 530, the processing component 535, and the processing component 540. Depending on implementation, the processing components may perform one or more processing actions in response to a request to perform a corresponding action or after obtaining corresponding sensor data.

In some implementations, one or more processing components of the system 500 may use one or more neural networks to process obtained sensor data. For example, the processing component 540 may use neural network 545 to process one or more components of the obtained sensor data. The neural network 545 may be trained using one or more sets of training data corresponding to sensor data obtained by devices of the system 500 or other devices.

Processing results obtained by processing components of the system 500 may be sent to a user, stored, or sent back to one or more devices for further obtaining of sensor data or to be provided to a user. In some cases, processing results of the processing components of the system 500 can include identification results, such as an identification of the person 505 as corresponding to the known individual “John Smith”. In general, any object may be identified by corresponding processes performed by the processing components of the system 500. In addition, sensor data obtained by the devices of the system 500 may be processed and re-rendered as data of another type or as data from a different sensor. In some cases, this data may be used for additional processes such as event driven fusion, identification, or alerting the user to one or more items of interest based on predetermined rules.

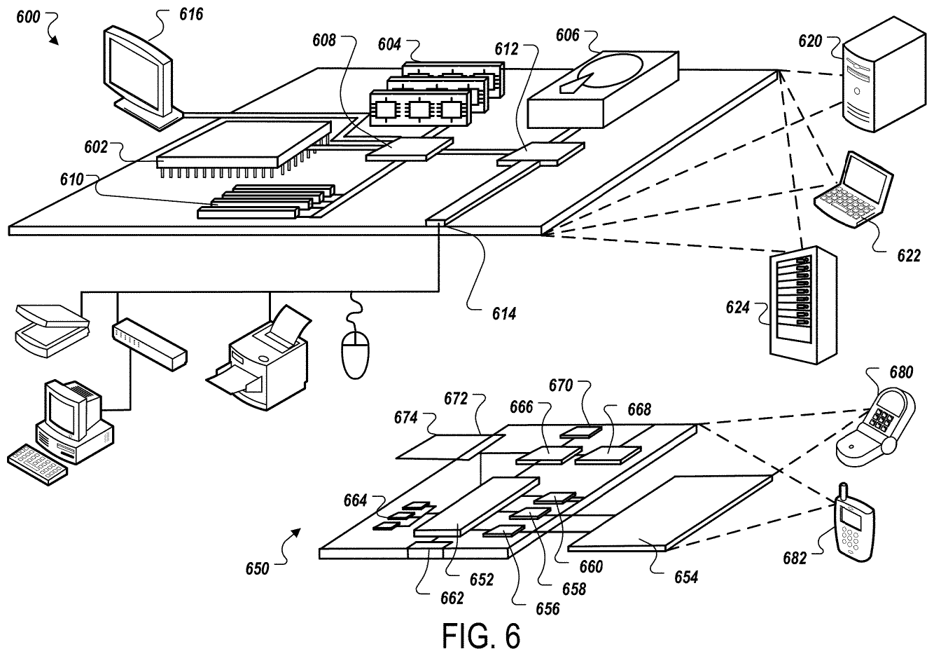

FIG. 6 is a diagram illustrating an example of a computing system used for multi-modal fusion. The computing system includes computing device 600 and a mobile computing device 650 that can be used to implement the techniques described herein. For example, one or more components of the system 100 could be an example of the computing device 600 or the mobile computing device 650, such as a computer system implementing the event driven fusion 110, devices that access information corresponding to the event driven fusion 110, or a server that accesses or stores information regarding the event driven fusion 110. As another example, one or more components of the system 200 could be an example of the computing device 600 or the mobile computing device 650, such as the generators 210, the event driven fusion 215 based on the output of the generators 210, devices that access information from the generators 210 or event driven fusion 215, or a server that accesses or stores information regarding the operations corresponding to the generators 210 or event driven fusion 215.

The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 602 is a single threaded processor. In some implementations, the processor 602 is a multi-threaded processor. In some implementations, the processor 602 is a quantum computer.

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine readable mediums (for example, the memory 604, the storage device 606, or memory on the processor 602).The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may include one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry in some cases. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 668 using a radio frequency. In addition, short-range communication may occur, such as using a Bluetooth, Wi-Fi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, among others) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

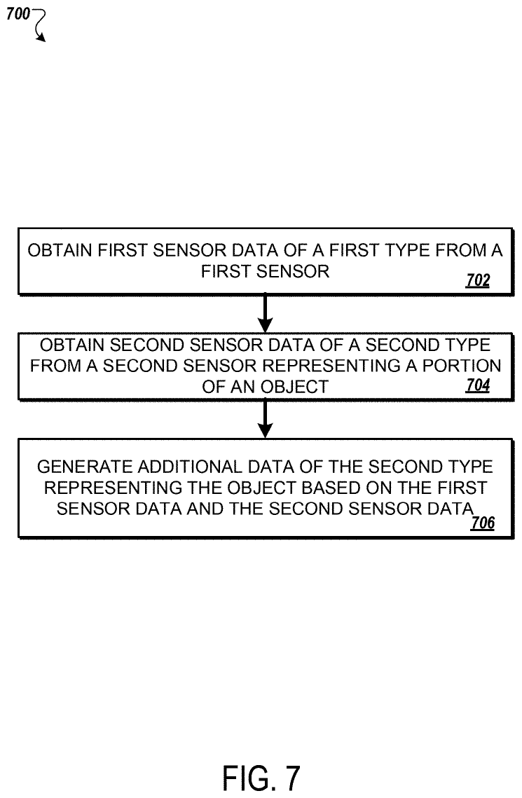

FIG. 7 is a flow diagram illustrating an example of generating additional data of a data type. The process 700 may be performed by one or more electronic systems, for example, the system 100 of FIG. 1 or the system 200 of FIG. 2.

The process 700 includes obtaining first sensor data of a first type from a first sensor (702). For example, a sensor of the sensor stack 105 can obtain data of a first type. In some cases, a visual camera of the sensor stack 105 can obtain data of a visual data type. A LIDAR sensor of the sensor of the sensor stack 105 can obtain data of a visual data type based on light detection and ranging. In general, each sensor of a sensor stack can obtain data of a corresponding data type. The first sensor data of the first type can include data representing an object passing the sensor stack 105 within a sensing threshold distance.

The process 700 includes obtaining second sensor data of a second type from a second sensor representing a portion of an object (704). In some cases, the second sensor data of the second type can represent a portion of an object detected by the second sensor. For example, the LIDAR sensor 105a of the sensor stack 105 can obtain data of a second type, such as visual data representing the light detection and ranging within an environment. In some cases, both the first sensor data and the second sensor data include data representing the same object as it passes the sensor stack 105 within a sensing threshold distance for the particular sensor that obtains the data.

The process 700 includes generating additional data of the second type representing the object based on the first sensor data and the second sensor data (706). For example, as shown in FIG. 1, the LIDAR sensor 105a can be replaced by the synthetic LIDAR sensor 105b. In some cases, the synthetic LIDAR sensor 105b includes a neural network that obtains data from at least one other sensor of the sensor stack 105 and generates LIDAR sensor data based on a learned relation between the obtained data of the at least one other sensor and previously obtained LIDAR sensor data during training. In this way, if the LIDAR sensor 105a is broken, the victim of an adversarial attack, influenced by environmental degradation effects, such as inclement weather, dust, or imperfections on a sensing part of the LIDAR sensor 105a (e.g., a lens, antenna, or the like), the synthetic LIDAR sensor 105b can still provide LIDAR data for the event driven fusion 110. In general, models can augment or replace any damaged, defective, or non-existent sensor. Models can also generate any type of sensor data depending on implementation.

In some implementations, generating the additional data representing the object includes providing the sensor data of the first type and the sensor data of the second type to a trained neural network, wherein the trained neural network is trained using a plurality of data types to learn one or more latent spaces among the plurality of data types, the one or more latent spaces including a latent space between the first type and the second type. For example, the system 100, as well as the system 200, can include a trained neural network to generate data of a specific type based on one or more data of one or more other types. Trained neural networks can include one or more GANs as shown in FIG. 2.

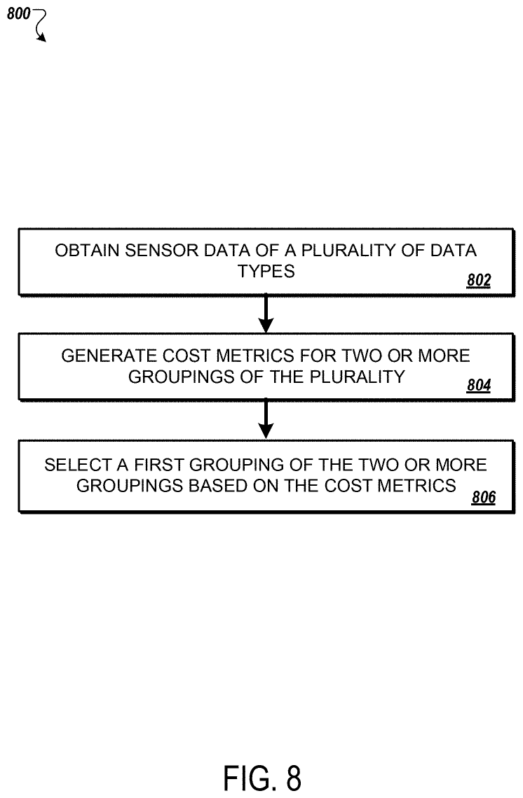

FIG. 8 is a flow diagram illustrating an example of adjusting a sensor stack based on cost metrics. The process 800 may be performed by one or more electronic systems, for example, the system 100 of FIG. 1 or the system 200 of FIG. 2.

The process 800 includes obtaining sensor data of a plurality of data types (802). For example, the system 100, including one or more processors that can be used to control the processes of the system 100, can obtain data from one or more sensors of the sensor stack 105 including a visual camera, FLIR sensor, acoustic sensor, Bluetooth sensor, among others.

The process 800 includes generating cost metrics for two or more groupings of the plurality (804). For example, the system 100 can determine the deployment as well as operational costs for each sensor of the sensor stack 105. The system 100 can determine what data can be synthetically generated based on models trained to generate data. In some cases, models for each sensor data generation can include a quality indicator that indicates the quality of the generated sensor data. The system 100 can compare the cost for each sensor with a quality indicator indicating the quality of the output of a model trained to generate data of a data type obtained by the given sensor. The system 100 can bias the cost metric, e.g., by one or more weights, based on a quality indicator where a higher quality indicator, or indicator that satisfies a threshold, corresponds to a higher cost metric because the data obtained by the sensor may be effectively generated by a trained model and its inclusion should be disincentivized.

For another example, a first group of the two or more groups can include an acoustic and GPS sensor. The cost for the group may be low compared to other groups but the data obtained may be unhelpful or unable to generate other data types. That is, it may be difficult to train a model to generate LIDAR data based on GPS and acoustic data. The system 100 can generate cost metrics for each group that account for the other data types the group of sensors could enable. That is, a sensor may be costly to deploy or operate but if it enables synthetic generation of one or more other sensors, the net cost may be less if the one or more other sensors do not need to be deployed or operated.

In some implementations, the cost metrics are calculated as a function of one or more of a size of a given sensor, a weight of a given sensor, power requirements of a given sensor, or a cost of a given sensor where the given sensor is used to obtain sensor data of a data type of the plurality of data types.

The process 800 includes selecting a first grouping of the two or more groupings based on the cost metrics (806). For example, the system 100 can rank or sort groupings based on cost metrics and choose a top performing grouping. In some cases, the system 100 can choose a grouping that includes the visual camera, acoustic sensor, and a Bluetooth sensor. The grouping can provide sensor data to one or more models to generate data of one or more other data types if necessary. Both the obtained data and synthetically generated data can be used in the event driven fusion 110 to identify other events. In some cases, synthetic data is only generated if an object is detected in a sensing range of the sensor stack 105. In some cases, synthetic data is only generated to match the data of events in a database used for searching and identifying events such that the data types of a generated fusion event matches the data types of previously generated fusion events.

In some implementations, the grouping selected by the system 100 determines changes to sensor stacks. For example, the system 100 can control other sensor stacks and, based on the cost effective analysis of the cost metrics, can generate a data signal configured to turn off one or more sensors not included in a selected cost effective grouping and transmit the data signal to one or more sensor stacks such that the receiving sensor stack shuts down operation of the sensors. The receiving sensor stack can include the sensor stack 105. The receiving sensor stack can provide data to a trained neural network model running locally on processors of the sensor stack or provide the data to a trained neural network running remotely. In some cases, the system 100 provides details about a trained model to a receiving sensor stack to enable the sensor stack to synthetically generate one or more data types based on one or more other obtained data types specific to the receiving sensor stack. The selection can also be used for deploying sensor stacks such that a minimal number of sensors can be deployed and used in the field.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention are described herein. Other embodiments are within the scope of the following claims. For example, the steps recited in the claims can be performed in a different order and still achieve desirable results.

In some implementations, a system may determine whether to process sensor data centrally or by using edge computing. For example, in a given system, including one or more sensors, such as the one or more sensors of the sensor stack 105, may have a known processing performance per unit of energy for each sensor or the sensor stack. Depending on the availability of energy (e.g., whether the sensors are powered by battery, cyclic processes such as solar or wind, cost in the given region, among others) the system may determine to route data from the sensors to a central computer for processing. For example, in the system 500, a corresponding control unit or one or more processing components may determine, based on energy usage, that sending sensor data to the processing components instead of spending the energy processing the data with the sensors may reduce the processing costs of the system 500.

In some implementations, a system may determine whether to process sensor data centrally or by using edge computing based on bandwidth considerations. For example, if bandwidth at a given time or location is limited, such as if the available bandwidth satisfies a determined threshold, a system, such as the system 500 of FIG. 5 may determine that it would be more efficient to perform one or more processes using computers located at the sensors or included in the sensors to reduce or eliminate the data to be sent over a network. For example, instead of sending raw data to the processing components of the system 500 over the network 525, one or more of the sensors 510, 515, or 520 may process the raw data to generate resulting data that may occupy less memory of a computer or bandwidth over a network than the original raw sensor data. The sensors 510, 515, or 520 may then perform subsequent processes or send the resulting data to the processing components 530, 535, and 540.

In some implementations, a given task may be associated with one or more data types. For example, in tracking a car enrolled in a system where the car sends a unique tire pressure signal and is capture by corresponding tire pressure sensors positioned along a road, a system may turn off other sensors to save on resources such as bandwidth or power or to reduce costs. In general, any sensor, or group of sensors, may be used as a sufficient set for a given task. In some cases, a group of one or more sensors may be determined based on the group of sensors satisfying a threshold correlating their detections with ground truths. For example, a group of one or more sensors may be predictive for detecting and identifying a given object. Sensors not included in this group may be turned off if on the sensor stack, not generated if a synthetic sensor, or physically removed from a sensor stack, depending on implementation. This may be especially useful in a system that focuses on tracking a particular object or person at a given time where some sensor data may be more useful than others, such as data that is more correlated with ground truth values compared to other sensor data.

In some implementations, one or more sensors may be used to trigger obtaining data from one or more other sensors. For example, instead of running all sensors on a sensor stack, which may present energy, bandwidth, as well as longevity concerns, a subset of lower bandwidth or power intensive sensors, such as acoustic sensors, may run continuously while higher bandwidth or power intensive sensors, such as high-definition video cameras, may only turn on if other sensors obtain data that satisfies a threshold. For example, in tracking car movement on a road, an acoustic sensor may detect noise above a certain threshold or noise that is characteristic of a car, as determined by processors on the sensor stack or computing components on a central computer or computers, and a control unit of a system or the sensor stack may, in response to the sensor data obtained by the acoustic sensor, turn on the video camera to obtain sensor data. In this way, bandwidth and power usage may be reduced and longevity of sensors, or other equipment corresponding to sensors, like power sources, batteries, among others, may increase due to reduced usage.

What is claimed is:

1. A method comprising:
obtaining, from a first sensor, first sensor data corresponding to an object, wherein the first sensor data is of a first modality;
providing the first sensor data to a neural network trained to convert from the first modality to a second modality; and
generating second sensor data of the second modality corresponding to the object based at least on an output of the trained neural network, wherein the generated second sensor data is of the second modality that is different than the first modality.

2. The method of claim 1, further comprising training the neural network, wherein training the neural network comprises:
obtaining training data of the first modality;
generating third sensor data of the second modality using the neural network based on the training data of the first modality;
generating data of the first modality using the neural network based on the generated third sensor data of the second modality; and
adjusting one or more weights of the neural network based on a difference between the training data of the first modality and the generated data of the first modality.

3. The method of claim 1, further comprising:
detecting, using one or more other sensors, the object based on the generated second sensor data of the second modality.

4. The method of claim 3, wherein the object is a human or a vehicle.

5. The method of claim 1, wherein the neural network is trained using a plurality of data modalities to learn one or more latent spaces between at least two data modalities of the plurality of data modalities, wherein the at least two data modalities include the first modality and the second modality.

6. The method of claim 1, comprising:
obtaining, from a third sensor, third sensor data corresponding to the object wherein the third sensor data is of a third modality;
providing the third sensor data and the first sensor data to the trained neural network to generate the output of the trained neural network; and
generating the second sensor data of the second modality based on the output of the trained neural network.

7. The method of claim 1, comprising:
determining that the generated second sensor data of the second modality satisfies a threshold value; and
in response to determining that the generated second sensor data satisfies the threshold value, providing output to a user device indicating a capability of the neural network to replace data of the second modality obtained by a second sensor with the generated second sensor data.

8. The method of claim 7, wherein a distance between a location of the first sensor and a location of the second sensor satisfies a distance threshold.

9. The method of claim 7, wherein the first sensor and the second sensor are included within a sensor stack.

10. The method of claim 1, wherein generating the second sensor data of the second modality comprises:
generating, based on the first sensor data, additional data representing the object, wherein the additional data is of the second modality.

11. The method of claim 10, further comprising:
identifying the object based on the additional data of the second modality.

12. The method of claim 1, comprising:
obtaining, from a second sensor, third sensor data of the second modality, wherein the third sensor data represents a portion of the object.

13. The method of claim 12, wherein the third sensor data of the second modality is a result of data degradation and represents a portion of the object that is less than the whole object due to the data degradation.

14. The method of claim 13, wherein the data degradation is due to environmental conditions.

15. The method of claim 12, comprising:
providing the third sensor data of the second modality to the neural network trained to convert from the first modality to the second modality, wherein the output of the trained neural network is generated by processing the first sensor data and the third sensor data.

16. The method of claim 1, comprising:
generating a plurality of cost metrics for two or more groupings of a plurality of sensors used to obtain data, wherein a grouping of the two or more groupings includes at least one sensor of the plurality of sensors, and wherein the plurality of sensors includes the first sensor that obtains data of the first modality a second sensor that obtains data of the second modality; and
selecting a first grouping of the two or more groupings based on the plurality of cost metrics to be included in a sensor stack, wherein the first grouping includes the first sensor and not the second sensor.

17. The method of claim 16, wherein the plurality of cost metrics are calculated, for each of the two or more groupings, as a function of one or more of a size of each sensor in the grouping, a weight of each sensor in the grouping, power requirements of each sensor in the grouping, or a cost of each sensor in the grouping.

18. The method of claim 16, comprising:
generating a data signal configured to turn off one or more sensors in one or more sensor stacks, wherein the one or more sensors are not included in the selected first grouping; and
sending the data signal to the one or more sensor stacks.

19. A non-transitory, computer-readable medium storing one or more instructions executable by a computer system to perform operations comprising:
obtaining, from a first sensor, first sensor data corresponding to an object, wherein the first sensor data is of a first modality;
providing the first sensor data to a neural network trained to convert from the first modality to a second modality; and
generating second sensor data of the second modality corresponding to the object based at least on an output of the trained neural network, wherein the generated second sensor data is of the second modality that is different than the first modality.

20. A system, comprising:
one or more processors; and
machine-readable media interoperably coupled with the one or more processors and storing one or more instructions that, when executed by the one or more processors, perform operations comprising:
obtaining, from a first sensor, first sensor data corresponding to an object, wherein the first sensor data is of a first modality;
providing the first sensor data to a neural network trained to convert from the first modality to a second modality; and
generating second sensor data of the second modality corresponding to the object based at least on an output of the trained neural network, wherein the generated second sensor data is of the second modality that is different than the first modality.
